(19) United States
(12) Patent Application Publication
(10) Pub. No.: US 2007/0211005 A1
(43) Pub. Date: Sep. 13, 2007

(54) Gamma voltage generator

(76) Inventor: Yao-Jen Tsai, Tainan County (TW)

Correspondence Address: J.C. Patents, Inc., Suite 250, 4 Venture, Irvine, CA, 92618, US

(21) Appl. No.: 11/374,695

(22) Filed: Mar. 13, 2006

(51) Int. Cl. G09G 3/36

(52) U.S. Cl. 345/89

(57) ABSTRACT

A gamma voltage generator comprises a multiplexer circuit and a control circuit is provided. The multiplexer circuit receive a plurality of voltages and outputting a part of the voltages in accordance to a plurality of polarity signals, respectively. The control circuit outputs the polarity signals at different time points such that the output voltages do not change their polarities at the same time.

### BACKGROUND OF THE INVENTION

1. Field of Invention

The present invention relates to a gamma voltage generator for a flat panel display device. More particularly, the present invention relates to a gamma voltage generator for a liquid crystal display device.

2. Description of Related Art

For recent years, flat panel display devices, such as liquid crystal display (LCD) device, plasma display panel (PDP) display device and liquid crystal on silicon (LCOS) display device, are commonly used in daily life. Generally, these display devices includes two glass substrates and light emitting substance sealed between them. As shown in FIG. 1, the TFT-LCD includes a lower glass substrate 100 provided with a TFT array 102 as a switching element, an upper glass substrate 110 provided with a color filter layer 112, and a liquid crystal layer 120 injected between the two glass substrates 100 and 110. The TFT-LCD is a non-light-emitting device that obtains an image effect based on the electro-optical characteristics of the liquid crystal layer 120.

For driving an LCD device, a driver should be provided. Referring to FIG. 2, which is a circuit block diagram of a related art LCD device, the driver drives an LCD panel 210 by using a gate driver 220, a source driver 230, a gamma voltage generator 240, and a timing controller 250. In the LCD panel 210, a plurality of gate lines are arranged to cross a plurality of data lines. A TFT and a pixel electrode are arranged at each crossing portion of the gate and data lines. The gate driver 220 sequentially applies a driving signal to the gate lines. The source driver 230 applies a data signal to the data lines. The gamma voltage generator 240 applies a reference voltage to the source driver 230. The timing controller 250 applies various control signals and voltages to the gate driver 220 and the source driver 230.

To maintain a stable display quality of the LCD device, an exact and uniform gamma voltage is required. The gamma voltage is generated by a resistance string having a plurality of serially arranged resistors as shown in FIG. 3. As shown in FIG. 3, the related art gamma voltage generator includes two voltage strings 330 and 340 arranged in parallel between a power source voltage terminal Vdd and a ground voltage terminal Vss, an amplifier portion 350, two DAC (digital to analog converter) 360 and 370, a multiplexer circuit 380, and an output buffer set 390.

The respective voltage strings 330 and 340 include a plurality of resistors R1-R6 and R7-R12 serially connected to generate a plurality of gamma voltages through voltage division by the respective resistors. The plurality of gamma voltages generated by the respective voltage strings 330 and 340 are amplified by a corresponding amplifier of the amplifier portion 350. The amplified gamma voltages Vo1˜Vo5 are output to DAC 360 while the amplified gamma voltages Vo6˜Vo10 being output to DAC 370. At this time, gray voltages of a positive frame are set by the voltages Vo1′ to Vo5′ output from the DAC 360 while gray voltages of a negative frame are set by the voltages Vo6′ to Vo10′ output from the DAC 370.

To output gamma voltages in accordance to whether a frame is a positive frame or a negative frame, the multiplexer circuit 380 usually comprises a multiplexer with a plurality of output terminals or a plurality of multiplexers 381˜385 as shown in FIG. 3. The multiplexer 381 receives and selectively outputs one of the analog gamma voltages Vo1′ and Vo6′. The multiplexer 382 receives and selectively outputs one of the analog gamma voltages Vo2′ and Vo7′. The multiplexer 383 receives and selectively outputs one of the analog gamma voltages Vo3′ and Vo8′. The multiplexer 384 receives and selectively outputs one of the analog gamma voltages Vo4′ and Vo9′. The multiplexer 385 receives and selectively outputs one of the analog gamma voltages Vo5′ and Vo10′.

After selected by the multiplexer circuit 380, the output buffer set 390 receives analog gamma voltages Vo1′˜Vo5′ when the frame is a positive frame and receives analog gamma voltages Vo6′˜Vo10′ when the frame is a negative frame. The output buffer set 390 comprises buffers 391˜395 to respectively buffer the analog gamma voltages. The analog gamma voltages buffered in the buffers 391˜395 are output as gamma voltages GMA[1]˜GMA[5].

However, because the selected gamma voltages output by the output buffer set 390 change their polarities at the same time as the frame changing its polarity, the gamma voltage generator suffers a problem that the EMI (Electro-Magnetic Interference) effect is large.

### SUMMARY OF THE INVENTION

One of the objects of the invention is to provide a gamma voltage generator that reduces the EMI effect while changing polarities of the frames.

To at least achieve the above and other objects, the invention provides a gamma voltage generator which comprises a select circuit and a control circuit. The select circuit receives a plurality of voltages and outputting a part of the voltages in accordance to a plurality of polarity signals, respectively. The control circuit outputs the polarity signals at different time points such that the output voltages do not change their polarities at the same time.

In one embodiment of the present invention, the control circuit comprises a plurality of flip-flops. The flip-flops are connected in cascade such that an input terminal of each one of the flip-flops, except a first one of the flip-flops, is coupled to an output terminal of another one of the flip-flops. Further, the input terminal of the first one of the flip-flops receives an original polarity signal and the flip-flops are operated according to a clock signal such that the flip-flops respectively output one of the polarity signals at different time points.

Accordingly, the polarities of the gamma voltages do not change at the same time such that the EMI effect can be reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structure diagram of a related art LCD device.

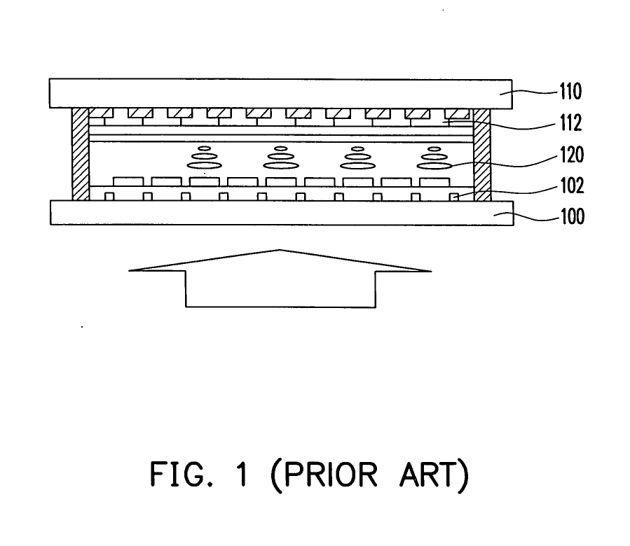

FIG. 2 is a circuit block diagram of a related art LCD device.

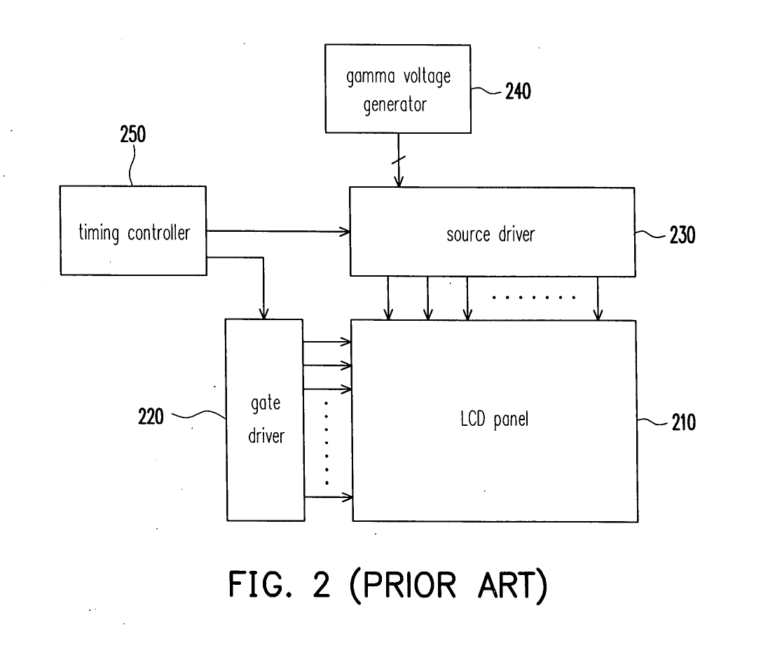

FIG. 3 is a circuit diagram of a related art gamma voltage generator.

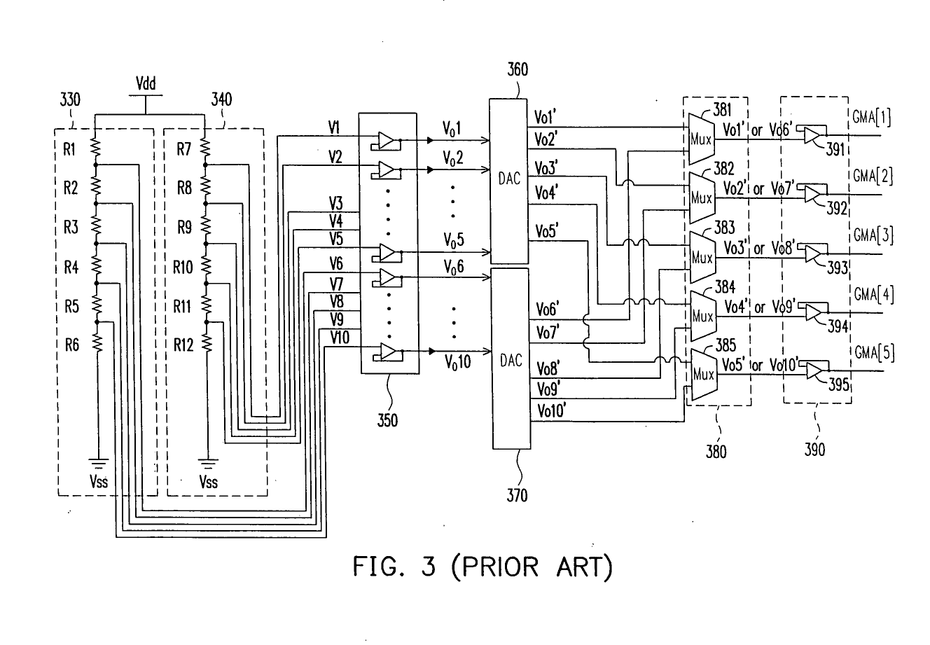

FIG. 4 is a circuit diagram of a gamma voltage generator according to one embodiment of the present invention.

FIG. 5 is a circuit diagram of a control circuit according to one embodiment of the present invention.

FIG. 6 is a timing diagram showing gamma voltage polarity according to FIG. 5.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

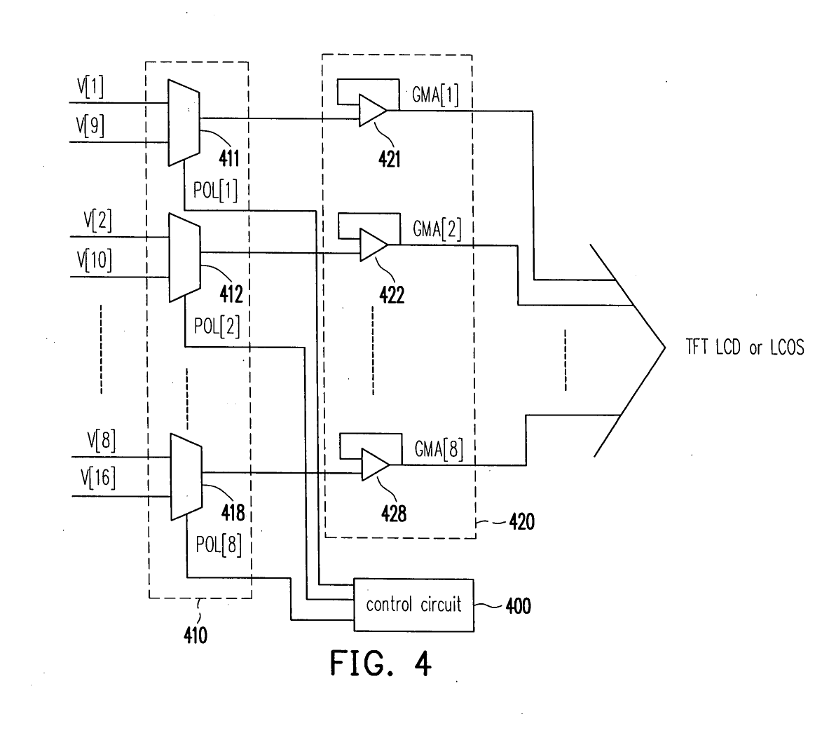

FIG. 4 is a circuit diagram of a gamma voltage generator according to one embodiment of the present invention. In the embodiment, the gamma voltage generator comprises a control circuit 400 and a multiplexer circuit 410. The multiplexer circuit 410 receives a plurality of voltages V[1:8] and V[9:16], wherein V[1:8] denotes eight voltages with positive polarity and V[9:16] denotes eight voltages with negative polarity. Normally, one of the gamma voltages V[1:8] has a corresponding gamma voltage with opposite polarity in the gamma voltages V[9:16].

Further, in the embodiment, the multiplexer circuit 410 comprises a plurality of multiplexers 411˜418. Each of the multiplexer 411˜418 receives one of the voltages V[1:8] and a corresponding one of the voltages V[9:16], and selectively outputs one of the received voltages. For example, the multiplexer 411 receives and selectively outputs one of the voltages V[1] and V[9], the multiplexer 412 receives and selectively outputs one of the voltages V[2] and V[10], and the multiplexer 418 receives and selectively outputs one of the voltages V[8] and V[16].

The multiplexer circuit 410 selects to output the voltages V[1:8] or the voltages V[9:16] according to the polarity signals POL[1:8] output from the control circuit 400. For example, when the polarity signal POL[1] is logic high, the multiplexer 411 selects to output voltage V[1]. Further, when the polarity signal POL[1] is logic low, the multiplexer 411 selects to output voltage V[9], which is the corresponding voltage with polarity opposite to voltage V[1]. Similarly, the multiplexer 412 selects to output voltage V[2] when the polarity signal POL[2] is logic high and output voltage V[10] when the polarity signal POL[2] is logic low, and the multiplexer 418 selects to output voltage V[8] when the polarity signal POL[8] is logic high and output voltage V[16] when the polarity signal POL[8] is logic low.

The output voltages may be directly transmits to TFT LCD device or LCOS device; however, they may be stabilized or even amplified by an output buffer circuit 420 before being output to the TFT LCD device or LCOS device as in the embodiment. In the embodiment, the output buffer circuit 420 comprises buffers 421˜428 for respectively receiving one of the outputs from the multiplexer circuit 410. For example, buffer 421 receives one of the voltages V[1] and V[9] and outputs the received voltage as the gamma voltage GMA[1], buffer 422 receives one of the voltages V[2] and V[10] and outputs the received voltage as the gamma voltage GMA[2], and the buffer 428 receives one of the voltages V[8] and V[16] and outputs the received voltage as the gamma voltage GMA[8].

For reducing EMI effect caused by changing polarities of the gamma voltages, the polarity signals POL [1:8] should be set such that the polarities of the gamma voltages GMA[1:8] are not changed at the same time.

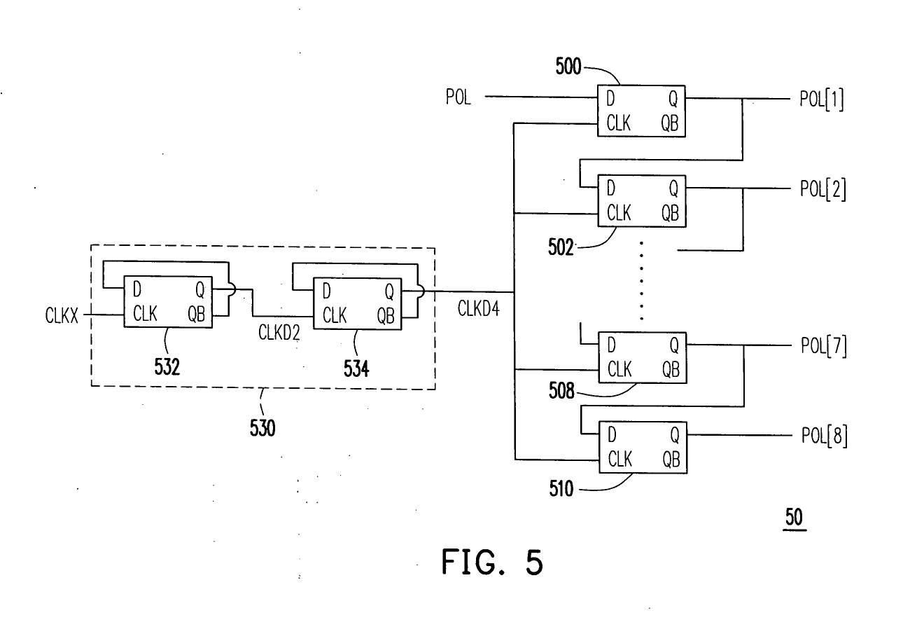

Refer to FIG. 5, which is a circuit diagram of a control circuit according to one embodiment of the present invention, the control circuit 50 mainly comprises several flip-flops 500˜510. The input terminal D of the flip-flop 500 receives an original polarity signal POL and the flip-flops 500˜510 are operated in accordance to a clock signal CLKD4. Further, the flip-flops 500˜510 are connected in cascade such that, except the first flip-flop 500, the input terminal D of the flip-flops are coupled to the output terminal Q of their preceding flip-flops. For example, the input terminal D of the flip-flop 502 is coupled to the output terminal Q of its preceding flip-flop 500, and the imputer terminal D of the flip-flop 510 is coupled to the output terminal Q of its preceding flip-flop 508.

The flip-flops 500˜510 function as a series of shift register such that one of the polarity signals POL[1:8], i.e., one of the polarity signals POL[1], POL[2], . . . , POL[7] and POL[8], is output by corresponding one of the flip-flops 500˜510.

Moreover, for further reducing EMI effect, the embodiment provides a clock signal generating circuit 530 for generating the clock signal CLKD4 from a clock signal CLKX used by other circuit in the voltage generator. Refer to FIG. 5, the clock signal generating circuit 530 comprises two flip-flops 532 and 534. The flip-flop 532 operates in accordance to the clock signal CLKX. The output terminal QB of the flip-flop 532 is coupled to its input terminal D, and the output terminal Q of the flip-flop 532 generates a clock signal CLKD2. Further, the flip-flop 534 operates in accordance to the clock signal CLKD2. The output terminal QB of the flip-flop 534 is coupled to its input terminal D, and the output terminal Q of the flip-flop 534 generates the clock signal CLKD4.

In practical application, frequency of the clock signal CLKX is about 70 MHz while used as clocking signal for a display apparatus. Accordingly, frequency of the clock signal CLKD4 is about 18 MHz and is enough for switching polarity signals POL[1:8]. However, the present invention can work normally even the clock signal generating circuit 530 is removed therefrom.

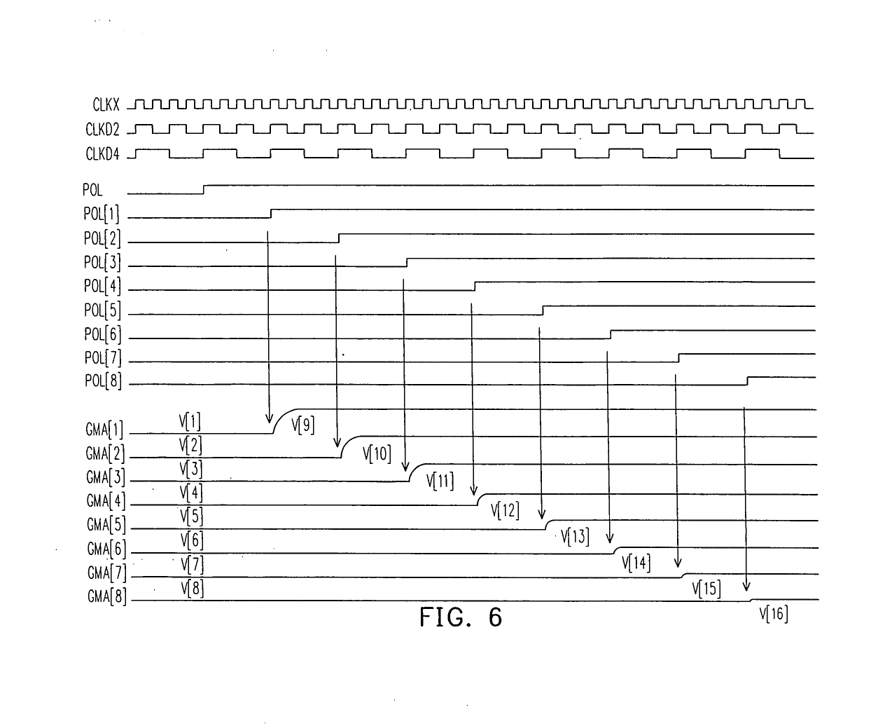

Refer to FIG. 6, which is a timing diagram showing gamma voltage polarity according to FIG. 5, the period of the clock signal CLKD4 is twice as the period of the clock signal CLKX because the clock signal generating circuit 530 is applied therein. As shown in FIG. 6, after the original polarity signal POL rises to logic high, the polarity signal POL[1] rises to logic high (V[1] in this embodiment) after 1 clock cycle of the clock signal CLKD4. Thereafter, polarity signals POL[2], POL[3] . . . etc., rise to logic high (V[2], V[3], . . . etc.) at different time points. Accordingly, the gamma voltage GMA[1], GMA[2], . . . etc., also changes their polarities at different time points.

After experiment, in the embodiment, the peak current occurred when the polarities of the gamma voltages change is lower than the peak current occurred while using the prior art technique. Accordingly, the present invention can reduce the EMI effect occurred due to polarity change.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A gamma voltage generator, comprising:
a select circuit, receiving a plurality of voltages and outputting a part of the voltages in accordance to a plurality of polarity signals respectively; and
a control circuit, outputting the polarity signals at different time points.

2. The gamma voltage generator of claim 1, further comprising:
an output buffer circuit, coupling to the select circuit for receiving and outputting the part of the voltages output from the select circuit.

3. The gamma voltage generator of claim 1, wherein the control circuit comprises:
a plurality of flip-flops, which are connected in cascade such that an input terminal of each one of the flip-flops, except a first one of the flip-flops, is coupled to an output terminal of another one of the flip-flops, and the input terminal of the first one of the flip-flops receives an original polarity signal,
wherein, the flip-flops are operated in accordance to a clock signal and output the polarity signals respectively.

4. The gamma voltage generator of claim 3, wherein the control circuit further comprising:
a clock signal generating circuit for generating the clock signal.

5. The gamma voltage generator of claim 1, wherein the part of the voltages output from the select circuit are sent to an LCD panel.

6. The gamma voltage generator of claim 1, wherein the part of the voltages output from the select circuit are sent to an LCOS display panel.
